(19) United States
(12) Patent Application Publication
(10) Pub. No.: US 2025/0266496 A1
(43) Pub. Date: Aug. 21, 2025

(54) NEGATIVE ELECTRODE COMPOSITE MATERIAL FOR FLUORIDE ION BATTERY, AND FLUORIDE ION BATTERY

(71) Applicant: TOYOTA JIDOSHA KABUSHIKI KAISHA, Toyota-shi (JP)

(72) Inventor: Kousuke NOI, Uji-shi (JP)

(73) Assignee: TOYOTA JIDOSHA KABUSHIKI KAISHA, Toyota-shi (JP)

(21) Appl. No.: 19/021,593

(22) Filed: Jan. 15, 2025

(30) Foreign Application Priority Data
Feb. 20, 2024 (JP) 2024-023761

(51) Int. Cl. H01M 10/0562; H01M 4/38

(52) U.S. Cl. CPC H01M 10/0562; H01M 4/387; H01M 2300/008

(57) ABSTRACT

An object of the present disclosure is to provide a negative electrode composite material for a fluoride ion battery that exhibits improved capacity retention, and a fluoride ion battery comprising the negative electrode composite material. The negative electrode composite material for a fluoride ion battery of the disclosure includes, in the discharged state, simple tin metal and a fluoride comprising a lanthanoid element. At least one of the lanthanoid elements is cerium. The negative electrode composite material for a fluoride ion battery of the disclosure comprises a mixture of simple tin metal and a simple lanthanoid element metal in the charged state, and/or an alloy of tin and a lanthanoid element. At least one of the lanthanoid elements is cerium, with the ratio of the number of moles of tin with respect to the number of moles of the lanthanoid element being 1.0 or greater.

### FIELD

The present disclosure relates to a negative electrode composite material for a fluoride ion battery and to a fluoride ion battery.

### BACKGROUND

Lithium ion batteries are known as high voltage and high energy density batteries. A lithium ion battery is a cation based battery which uses lithium ion as the carrier. Fluoride ion batteries, on the other hand, are known as anion based batteries which use fluoride ion as the carrier.

It is a known technique to use a fluoride comprising a lanthanoid element as the solid electrolyte in a fluoride ion battery.

PTL 1, for example, discloses a fluoride ion battery wherein the solid electrolyte layer comprises a solid electrolyte material such as La₁₋ₓBaₓF₃₋ₓ (0≤x≤2) or Ce₁₋ₓBaₓF₃₋ₓ (0≤x≤2), and a simple metal such as Pb, Sn, In, Bi or Sb.

PTL 2 discloses a solid electrolyte to be used in a fluoride ion battery, wherein the solid electrolyte has the composition Ce_{1-x-y}LaₓSr_{y}F_{3-y} (0<x, 0<y, 0<x+y<1), and has a crystal phase with a tysonite structure.

### CITATION LIST

### Patent Literature

[PTL 1] Japanese Unexamined Patent Publication No. 2018-077987
[PTL 2] Japanese Unexamined Patent Publication No. 2020-102393

### SUMMARY

### Technical Problem

In the fluoride ion batteries of PTLs 1 and 2, the solid electrolyte forms a self-forming negative electrode active material layer. In other words, all or part of the substance that carries out the function of solid electrolyte during charge-discharge reaction of the battery also functions as the negative electrode active material. However, fluoride ion batteries with this type of charge-discharge reaction mechanism still have potential for improvement in terms of capacity retention.

It is an object of the present disclosure to provide a negative electrode composite material for a fluoride ion battery that exhibits improved capacity retention, and a fluoride ion battery comprising the negative electrode composite material.

### Solution to Problem

The present inventors have found that the aforementioned object can be achieved by the following means.

### <Aspect 1>

A negative electrode composite material for a fluoride ion battery, comprising:
in the discharged state, simple tin metal and a fluoride which comprises a lanthanoid element,
wherein at least one of the lanthanoid elements is cerium, and
wherein the ratio of the number of moles of tin with respect to the number of moles of the lanthanoid element is 1.0 or greater.

### <Aspect 2>

The negative electrode composite material according to aspect 1, wherein the ratio of the number of moles of cerium with respect to the total number of moles of elements other than fluorine in the fluoride is 0.5 or greater.

### <Aspect 3>

The negative electrode composite material according to aspect 1 or 2, wherein the fluoride is a compound represented by the following formula (1):

Ce₁₋ₓBaₓF₃₋ₓ: (1)
wherein, x is 0.02 or greater and 0.3 or less.

### <Aspect 4>

A negative electrode composite material for a fluoride ion battery, comprising:
in the charged state, a mixture of simple tin metal and a simple lanthanoid element metal, and/or an alloy of tin and a lanthanoid element,
wherein at least one of the lanthanoid elements is cerium, and
wherein the ratio of the number of moles of tin with respect to the number of moles of the lanthanoid element is 1.0 or greater.

### <Aspect 5>

A fluoride ion battery, comprising:
a negative electrode active material layer,
wherein the negative electrode active material layer comprises a negative electrode composite material according to any one of aspects 1 to 4.

### Advantageous Effects of Invention

According to the present disclosure it is possible to provide a negative electrode composite material for a fluoride ion battery exhibiting improved capacity retention, and a fluoride ion battery comprising the negative electrode composite material.

### BRIEF DESCRIPTION OF DRAWINGS

FIG. 1 is a simplified cross-sectional view showing an example of a fluoride ion battery of the disclosure.

FIG. 2 is a charge-discharge curve for the fluoride ion battery of Example 1.

FIG. 3 is a charge-discharge curve for the fluoride ion battery of Comparative Example 1.

FIG. 4 is a graph showing the discharge capacity for the fluoride ion batteries of Examples 1 to 4.

FIG. 5 is a graph showing the discharge capacity for the fluoride ion batteries of Comparative Examples 1 and 2.

### DESCRIPTION OF EMBODIMENTS

An embodiment of the disclosure will now be described in detail. However, it should be noted that the disclosure is not limited to the embodiment described below, and various modifications may be implemented which do not depart from the gist thereof.

### <<Negative Electrode Composite Material for Fluoride Ion Battery>>

The negative electrode composite material for a fluoride ion battery of the disclosure includes, in the discharged state, simple tin metal and a fluoride comprising a lanthanoid element. At least one of the lanthanoid elements is cerium. The ratio of the number of moles of tin with respect to the number of moles of the lanthanoid element is 1.0 or greater.

The present inventors have found, unexpectedly, that in the discharged state, a negative electrode composite material that includes simple tin (Sn) metal and a fluoride comprising a lanthanoid element (Ln) including at least cerium (Ce), and wherein the Sn/Ln (molar ratio) is 1.0 or greater, can provide improved capacity retention for a fluoride ion battery. Without being restricted to any particular theory, the reason for this is believed to be as follows. Specifically since the metal/fluoride (molar) ratio and the type of metal affects the compositional ratio and type of the reaction product in the defluorination reaction that takes place upon charge, the ease of progression of the refluorination reaction that takes place upon discharge is therefore also presumably affected. This creates a difference in the reversibility of the battery reaction under the action of a constant current. The factors which affect ease of progression of the discharge reaction include the interfacial reaction rate and the fluoride ion diffusion rate. The negative electrode composite material of the disclosure has the metal/fluoride (molar) ratio and the type of metal appropriately designed so as to allow improvement in the capacity retention of the battery.

### <Simple Tin Metal>

The negative electrode composite material for a fluoride ion battery of the disclosure includes a simple tin metal in the discharged state. The simple tin metal can form an alloy with the simple lanthanoid element metal that is produced by defluorination reaction that takes place upon charge.

### <Fluoride Comprising Lanthanoid Element>

The negative electrode composite material for a fluoride ion battery of the disclosure also includes a fluoride comprising a lanthanoid element, in the discharged state. At least one of the lanthanoid elements in the fluoride is cerium. The lanthanoid element may also include lanthanum in addition to cerium. The fluoride produces a simple lanthanoid element metal by the defluorination reaction that takes place upon charge. The simple lanthanoid element metal can form an alloy with the simple tin metal.

In the negative electrode composite material for a fluoride ion battery of the disclosure, the ratio of the number of moles of tin with respect to the number of moles of the lanthanoid element (Sn/Ln molar ratio) is 1.0 or greater. The Sn/Ln (molar) ratio may be 1.5 or greater, 2.0 or greater, 2.5 or greater or 3.0 or greater, and 5.0 or less, 4.0 or less, 3.5 or less or 3.0 or less. If the Sn/Ln (molar) ratio is within this range, it is then possible to substantially improve the capacity retention of the battery. A Sn/Ln (molar) ratio of near 3.0, in particular, can increase the discharge capacity from the second discharge onward, for example, compared to the initial discharge capacity in a cycle test. This is thought to be because with a Sn:Ln=3:1 (molar) ratio, Sn-Ln alloy easily forms from the simple tin (Sn) metal and the simple lanthanoid element (Ln) metal produced by defluorination reaction that takes place upon charge, allowing the Sn-Ln alloy to substantially function as a negative electrode active material during discharge.

### <Alkaline Earth Metal>

The fluoride may also include an alkaline earth metal, for example, in addition to the lanthanoid element. The alkaline earth metal is not particularly limited, and examples include calcium, strontium and barium, and especially barium. The alkaline earth metal can improve the fluoride ion conductivity of the battery.

In particular, the fluoride may be a compound represented by the following formula (1):

Ce₁₋ₓBaₓF₃₋ₓ: (1)
wherein, x is 0.02 or greater and 0.3 or less.

The variable x may be 0.05 or greater, 0.08 or greater or 0.1 or greater, and 0.25 or less, 0.2 or less, 0.15 or less or 0.1 or less. More specifically, the fluoride may be the compound represented by Ce_{0.9}Ba_{0.1}F_{2.9}. If x is within this range, then the effect of improved fluoride ion conductivity of the battery by the alkaline earth metal such as barium will be even higher.

The ratio of the number of moles of cerium with respect to the total number of moles of elements other than fluorine in the fluoride is 0.5 or greater. In particular, when the fluoride comprises cerium, barium and fluorine, for example, the ratio of number of moles of cerium/(number of moles of cerium+number of moles of barium) may be 0.5 or greater. In this case the ratio may be 0.6 or greater, 0.7 or greater, 0.8 or greater or 0.9 or greater, and less than 1.0, or 0.9 or less. The ratio may also be 1.0. In other words, the only element other than fluorine in the fluoride may be cerium, in which case the fluoride may be cerium fluoride, represented by CeF₃.

The fluoride may be one prepared via reaction by application of mechanical impact on the starting compounds including the elements forming the fluoride, or it may be a commercial product. For example, when the fluoride is a compound represented by Ce₁₋ₓBaₓF₃₋ₓ, it may be prepared by mixing and reacting cerium fluoride (CeF₃) and barium fluoride (BaF₂). The mixing method may be a mechanical milling method, as an example. Specifically, the method may be mixing using a ball mill apparatus. When the fluoride is CeF₃, for example, a commercial product may be used.

The method of preparing the negative electrode composite material for a fluoride ion battery of the disclosure in the discharged state is not particularly limited, and may, for example, be a method of applying mechanical impact to the starting compounds. The method of applying mechanical impact may also be mixing by a mechanical milling method, as an example. Specifically, the method may be mixing using a ball mill apparatus.

The negative electrode composite material for a fluoride ion battery of the disclosure comprises a mixture of simple tin metal and a simple lanthanoid element metal in the charged state, and/or an alloy of tin and a lanthanoid element. At least one of the lanthanoid elements is cerium, with the ratio of the number of moles of tin with respect to the number of moles of the lanthanoid element being 1.0 or greater.

As mentioned above, defluorination reaction takes place by charging with the negative electrode composite material for a fluoride ion battery of the disclosure. This produces a defluorinated product from a simple metal lanthanoid element (Ln) and/or Sn-Ln alloy, and a fluoride. Specifically, when the negative electrode composite material for a fluoride ion battery of the disclosure in the discharged state is simple Sn metal and Ce_{0.9}Ba_{0.1}F_{2.9}, for example, simple Ce metal and/or Sn—Ce alloy, and BaF₂, are produced by defluorination reaction that takes place upon charge.

### <<Negative Electrode Mixture>>

The negative electrode composite material of the disclosure may form a negative electrode mixture. For the purpose of the disclosure, “negative electrode mixture” means a composition that can form a negative electrode active material layer, either alone or by further comprising other components. The negative electrode mixture may also optionally comprise a conductive aid and a binder.

### <Negative Electrode Composite Material>

The negative electrode composite material of the disclosure will be understood by referring to the aforementioned description of the negative electrode composite material of the disclosure.

### <Conductive Aid>

The conductive aid may be a carbon material, for example. Examples of carbon materials include carbon blacks such as acetylene black, Ketjen black, furnace black and thermal black, as well as graphene, fullerene and carbon nanotubes.

### <Binder>

Examples of binders include fluorine-based binders such as polyvinylidene fluoride (PvDF) and polytetrafluoroethylene (PTFE).

The method of preparing the negative electrode mixture is not particularly limited, and may be a method of mixing components that can form a negative electrode mixture, for example. The constituent components of the negative electrode composite material may also be mixed simultaneously with the other components. The mixing method may be a mechanical milling method, as an example. Specifically, the method may be mixing using a ball mill apparatus.

### <<Fluoride Ion Battery>>

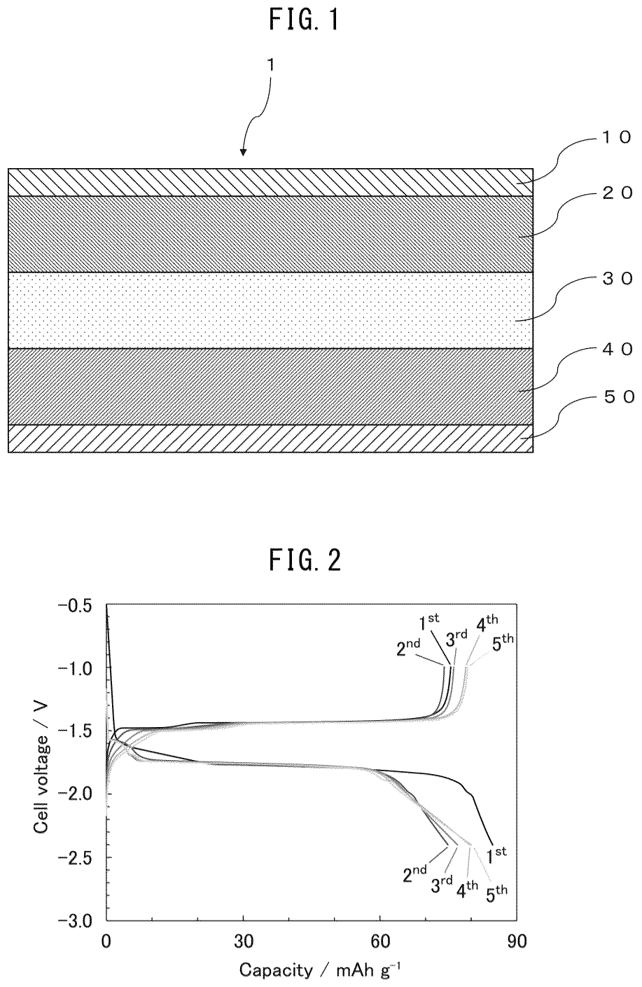

As illustrated in FIG. 1, the fluoride ion battery 1 of the disclosure comprises a negative electrode active material layer 20, the negative electrode active material layer comprising a negative electrode composite material of the disclosure. The negative electrode active material layer may also comprise a negative electrode mixture which includes a negative electrode composite material of the disclosure. The fluoride ion battery 1 of the disclosure may comprise a negative electrode collector 10, a negative electrode active material layer 20, an electrolyte layer 30, a positive electrode active material layer 40 and a positive electrode collector 50, in that order.

The fluoride ion battery of the disclosure may be a liquid battery comprising an electrolyte solution as the electrolyte layer, or it may be a solid-state battery having a solid electrolyte layer as the electrolyte layer. The term “solid-state battery” as used herein refers to a battery using at least a solid electrolyte as the electrolyte, and the solid-state battery may employ a combination of a solid electrolyte and a liquid electrolyte as the electrolyte. The solid-state battery of the disclosure may also be an all-solid-state battery, i.e. a battery employing only a solid electrolyte as the electrolyte.

### <Negative Electrode Collector>

Examples of materials for the negative electrode collector include stainless steel (SUS), copper, nickel, iron, titanium, platinum and carbon. The form of the negative electrode collector may be a foil, mesh or porous form.

### <Negative Electrode Active Material Layer>

The negative electrode active material layer may comprise a negative electrode composite material of the disclosure. The negative electrode composite material of the disclosure will be understood by referring to the aforementioned description of the negative electrode composite material of the disclosure.

The thickness of the negative electrode active material layer is not particularly limited, and may be appropriately set, depending on the battery construction.

### <Electrolyte Layer>

When the fluoride ion battery of the disclosure is a liquid battery, the electrolyte layer may be composed of an electrolyte solution and optionally a separator, for example.

The electrolyte solution may comprise a fluoride salt and an organic solvent, for example.

The separator is not particularly restricted, so long as it has a composition that can withstand the range of use of the fluoride ion battery.

When the fluoride ion battery of the disclosure is a solid-state battery, the electrolyte layer may include a solid electrolyte layer, for example. The electrolyte layer in this case may optionally comprise a binder.

The solid electrolyte is not particularly limited, so long as it is a material that can be used in a fluoride ion battery. For example, the solid electrolyte used may be one with a fluorination/defluorination potential which is more base (lower potential) than the fluoride which contributes to the battery reaction in the negative electrode active material layer.

The binder will be understood by referring to the aforementioned description of the negative electrode mixture of the disclosure.

### <Positive Electrode Active Material Layer>

The positive electrode active material layer of the disclosure is a layer comprising at least a positive electrode active material. The positive electrode active material layer may also optionally comprise a solid electrolyte, a conductive aid and a binder.

The positive electrode active material will usually be an active material which is defluorinated during discharge. Examples of positive electrode active materials include simple metals, alloys and metal oxides, as well as their fluorides. Examples of metal elements to be included in the positive electrode active material include Cu, Ag, Ni, Co, Pb, Mn, Au, Pt, Rh, V, Os, Ru, Fe, Cr, Bi, Nb, Sb, Ti, Sn and Zn.

The solid electrolyte may be understood by referring to the description regarding the electrolyte layer of the disclosure, and the conductive aid and binder may be understood by referring to the aforementioned description regarding the negative electrode mixture of the disclosure.

The thickness of the positive electrode active material layer is not particularly limited, and may be appropriately set depending on the battery construction.

### <Positive Electrode Collector>

Examples of materials for the positive electrode collector include lead, stainless steel (SUS), aluminum, nickel, iron, titanium, platinum and carbon. The form of the positive electrode collector may be a foil, mesh or porous form.

### EXAMPLES

### Example 1

### <Preparation of Negative Electrode Mixture Containing Negative Electrode Composite Material>

Predetermined amounts of simple tin (Sn) metal powder, cerium barium fluoride (Ce_{0.9}Ba_{0.1}F_{2.9}) powder as a fluoride comprising a lanthanoid element, and acetylene black carbon (AB) powder as a conductive aid, were mixed by mechanical milling using a ball mill apparatus (Premium Line PL-7 planetary ball mill by Fritsch Co.) to obtain a negative electrode mixture powder containing a negative electrode composite material. The Sn/Ce (molar) ratio was 1.0. The amount of AB added was 3 mass % of the total negative electrode mixture. The ball mill mixing was carried out with a platform rotation speed of 200 rpm in a dry argon atmosphere over a period of 3 hours.

<Fabrication of all-Solid-State Fluoride Ion Battery as Half Cell for Testing>

### (Formation of Negative Electrode Active Material Layer)

A green compact was formed using 15 mg of the negative electrode mixture powder, and a negative electrode active material layer (working electrode) was obtained from it.

### (Formation of Electrolyte Layer)

A green compact was formed using 150 mg of lanthanum barium fluoride (La_{0.9}Ba_{0.1}F_{2.9}) powder, and an electrolyte layer was obtained from it.

### (Formation of Positive Electrode Active Material Layer)

A green compact was formed using 50 mg of a mixture of lead fluoride (PbF₂) powder as a positive electrode active material and AB powder as a conductive aid, and a positive electrode active material layer (counter electrode) was obtained from it. The AB was present in the mixture in an amount of 5 mass % of the total mixture. A 220 mg Pb board was contact bonded onto one side surface of the formed positive electrode active material layer. In a charge-discharge test of the half cell it was shown that using a Pb board can provide an effect of inhibiting cycle capacity deterioration on the counter electrode side. However, the Pb board is not an essential construction for the present disclosure.

### (Fabrication of Battery)

A platinum foil as the negative electrode collector, a negative electrode active material layer, an electrolyte layer, a positive electrode active material layer and an aluminum foil as the positive electrode collector, were laminated in that order to fabricate an all-solid-state fluoride ion battery for Example 1. The Pb board was laminated in contact with the positive electrode collector. The diameter of the all-solid-state fluoride ion battery was 11.28 mm. The all-solid-state fluoride ion battery was set in a ceramic cylindrical container with an inner diameter of 11.28 mm, and anchored between stainless steel cylinders with a diameter of 11.28 mm from both the negative electrode collector and the positive electrode collector sides.

### Example 2

An all-solid-state fluoride ion battery for Example 2 was fabricated in the same manner as Example 1, except that the Sn/Ce (molar) ratio was 1.5.

### Example 3

An all-solid-state fluoride ion battery for Example 3 was fabricated in the same manner as Example 1, except that the Sn/Ce (molar) ratio was 3.0.

### Example 4

An all-solid-state fluoride ion battery for Example 4 was fabricated in the same manner as Example 3, except that the fluoride powder used as the starting material for the negative electrode composite material was cerium fluoride (CeF₃) instead of Ce_{0.9}Ba_{0.1}F_{2.9}.

### Comparative Example 1

An all-solid-state fluoride ion battery for Comparative Example 1 was fabricated in the same manner as Example 1, except that the Sn/Ce (molar) ratio was 0.5.

### Comparative Example 2

An all-solid-state fluoride ion battery for Comparative Example 2 was fabricated in the same manner as Example 3, except that simple indium (In) metal was used instead of simple Sn metal as the metal starting material for the negative electrode composite material, and La_{0.9}Ba_{0.1}F_{2.9} was used instead of Ce_{0.9}Ba_{0.1}F_{2.9} as the fluoride powder.

### Evaluation

Each of the fluoride ion batteries of the Examples was vacuum pumped in a sealed container while carrying out charge-discharge five times at a testing temperature of 140° C. and a current density of 0.05 mA/cm². For Example 4 and Comparative Example 2, however, charge-discharge was carried out 10 times. This was done to evaluate the relationship between capacity deterioration and number of times of charge-discharge. In the half cell for testing prepared for this purpose, the working electrode side (negative electrode side) was connected to the positive side wiring and the counter electrode side (positive electrode side) was connected to the negative side wiring, and therefore the cell voltage is shown as a negative value. With these settings, the applied final charge voltage and final discharge voltage were −2.4 V and −1.0 V, respectively. A frequency response analyzer-mounted electrochemical measurement system (VMP-300 high performance electrochemical measurement system by Bio-Logic) was used for the charge-discharge test. Due to defluorination reaction that takes place upon charge in this test, a mixture of simple Sn metal and simple Ce metal, and/or Sn—Ce alloy, were present in the negative electrode active material layer.

### Results

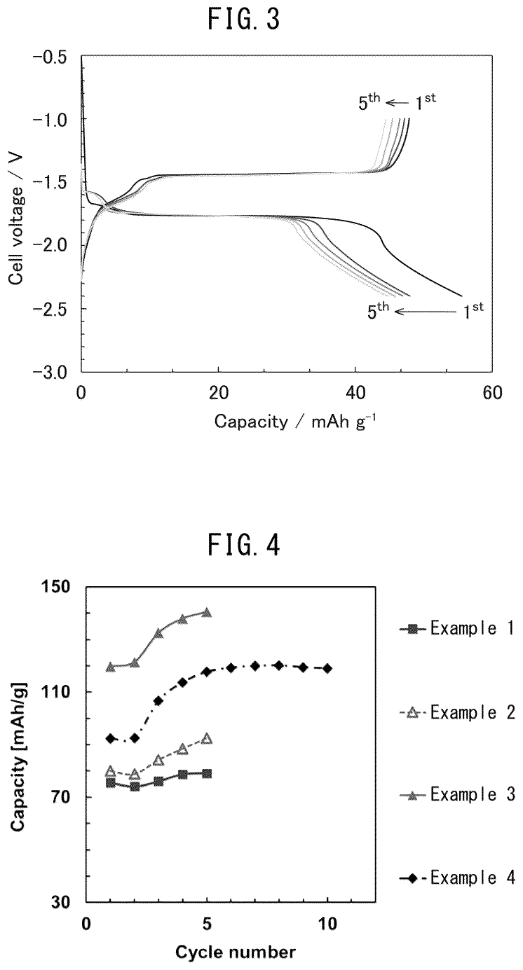

Charge-discharge curves for Example 1 and Comparative Example 1 are shown in FIGS. 2 and 3, as the results of the charge-discharge test. The side with increasing negative cell voltage value corresponds to charge, and the side with a value approaching 0 corresponds to discharge.

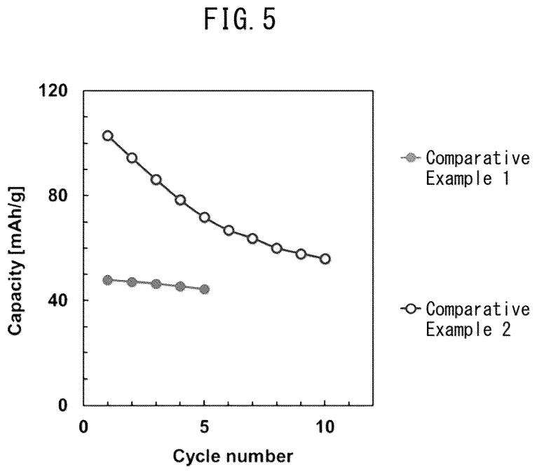

The results of charge-discharge testing for each Example, as changes in discharge capacity at each cycle, are shown in FIG. 4 (Examples) and FIG. 5 (Comparative Examples). The results for Example 4 and Comparative Example 2 confirmed that the presence or absence of capacity deterioration can be judged based on increase or reduction in discharge capacity from the 2nd cycle to the 5th cycle. The ratio of the discharge capacity at the 5th cycle with respect to the discharge capacity at the 2nd cycle was used as the capacity retention to judge the presence or absence of capacity deterioration. The discharge capacities at the 2nd and 5th cycles, and the capacity retentions, are shown in Table 1. A capacity retention of 100% or greater was judged as no capacity deterioration, while a capacity retention of less than 100% was judged as capacity deterioration. The discharge capacity in each test is represented as a specific capacity standardized for the weight of the negative electrode mixture.

TABLE 1

| | | | | 2nd Cycle | 5th Cycle | | Tendency to |
|---|---|---|---|---|---|---|---|
| | Metal | Ln-containing | M/Ln | discharge capacity | discharge capacity | Capacity retention | capacity |
| | M | fluoride | (molar ratio) | [mAh/g] | [mAh/g] | [%] | deterioration |
| Example 1 | Sn | Ce_{0.9}Ba_{0.1}F_{2.9} | 1 | 74.1 | 79.2 | 107 | No |
| Example 2 | Sn | Ce_{0.9}Ba_{0.1}F_{2.9} | 1.5 | 78.9 | 92.5 | 117 | No |
| Example 3 | Sn | Ce_{0.9}Ba_{0.1}F_{2.9} | 3 | 121.4 | 140.5 | 116 | No |
| Example 4 | Sn | CeF₃ | 3 | 92.6 | 117.6 | 127 | No |
| Comp. Example 1 | Sn | Ce_{0.9}Ba_{0.1}F_{2.9} | 0.5 | 47.2 | 44.4 | 94 | Yes |
| Comp. Example 2 | In | La_{0.9}Ba_{0.1}F_{2.9} | 3 | 94.5 | 71.8 | 76 | Yes |

As seen in FIGS. 2 to 5 and Table 1, capacity deterioration was inhibited with the batteries of the Examples which comprised a negative electrode composite material of the disclosure which included simple Sn metal and a fluoride comprising Ce as a lanthanoid element, and having a Sn/Ce (molar) ratio of 1.0 or greater. The discharge capacity was largest in Example 3 which included barium in the fluoride as the starting material for the negative electrode composite material, and which had a Sn/Ce (molar) ratio of 3.0.

### REFERENCE SIGNS LIST

1 Fluoride ion battery
10 Negative electrode collector
20 Negative electrode active material layer
30 Solid electrolyte layer
40 Positive electrode active material layer
50 Positive electrode collector

1. A negative electrode composite material for a fluoride ion battery, comprising:
in the discharged state, simple tin metal and a fluoride which comprises a lanthanoid element,
wherein at least one of the lanthanoid elements is cerium, and
wherein the ratio of the number of moles of tin with respect to the number of moles of the lanthanoid element is 1.0 or greater.

2. The negative electrode composite material according to claim 1, wherein the ratio of the number of moles of cerium with respect to the total number of moles of elements other than fluorine in the fluoride is 0.5 or greater.

3. The negative electrode composite material according to claim 1, wherein the fluoride is a compound represented by the following formula (1):
Ce₁₋ₓBaₓF₃₋ₓ: (1)
wherein, x is 0.02 or greater and 0.3 or less.

4. A negative electrode composite material for a fluoride ion battery, comprising:
in the charged state, a mixture of simple tin metal and a simple lanthanoid element metal, and/or an alloy of tin and a lanthanoid element,
wherein at least one of the lanthanoid elements is cerium, and
wherein the ratio of the number of moles of tin with respect to the number of moles of the lanthanoid element is 1.0 or greater.

5. A fluoride ion battery, comprising:
a negative electrode active material layer,
wherein the negative electrode active material layer comprises a negative electrode composite material according to claim 1.
